(19) United States
(12) Patent Application Publication
(10) Pub. No.: US 2015/0009252 A1
(43) Pub. Date: Jan. 8, 2015

(54) LIQUID DROP EJECTION STATE DETECTION DEVICE AND IMAGE FORMATION APPARATUS

(71) Applicants: Hiroshi Andoh, Ibaraki (JP); Hideharu Miki, Ibaraki (JP); Genichiro Kawamichi, Ibaraki (JP); Kohji Tokuyama, Ibaraki (JP); Shigeru Morinaga, Kanagawa (JP)

(72) Inventors: Hiroshi Andoh, Ibaraki (JP); Hideharu Miki, Ibaraki (JP); Genichiro Kawamichi, Ibaraki (JP); Kohji Tokuyama, Ibaraki (JP); Shigeru Morinaga, Kanagawa (JP)

(73) Assignee: Ricoh Company, Ltd., Tokyo (JP)

(21) Appl. No.: 14/318,391

(22) Filed: Jun. 27, 2014

(30) Foreign Application Priority Data
Jul. 8, 2013 (JP) 2013-142557

(51) Int. Cl. B41J 2/125

(52) U.S. Cl. CPC B41J 2/125
USPC 347/9

(57) ABSTRACT

A liquid drop ejection state detection device includes a plurality of nozzle sequences configured to have a plurality of nozzles, a light-emitting element configured to emit a light beam incident on a liquid drop from each nozzle of each nozzle sequence, a light-receiving element provided at a position outside a beam diameter of the light beam and configured to receive scattered light from the liquid drop and detect an ejection state of the liquid drop based on an amount of the scattered light, a light-emitting element movement part configured to move the light-emitting element in a direction intersecting with a light axis of the light beam, and an adjustment part configured to adjust an amount of light of the light beam emitted from the light-emitting element.

### CROSS-REFERENCE TO RELATED APPLICATION

This patent application is based on and claims priority pursuant to 35 U.S.C. §119(a) to Japanese Patent Application No. 2013-142557, filed on Jul. 8, 2013 in the Japan Patent Office, the entire disclosure of which is hereby incorporated by reference herein.

### BACKGROUND OF THE INVENTION

1. Field of the Invention

An aspect of the present invention relates to at least one of a liquid drop ejection state detection device and an image formation apparatus.

2. Description of the Related Art

In a serial-type image formation apparatus that forms an image by ejecting a liquid drop while a recording head moves in a main-scanning direction, or a line-type image formation apparatus using a line-type head that forms an image by ejecting a liquid drop on a condition that a recording head is not moved, an image quality is degraded as a defect of ejection is caused by an increase of an ink viscosity that is caused by vaporization of a solvent from a nozzle, solidification of an ink, attachment of dust, further admixing of an air bubble, or the like, because the recording head ejects an ink from a nozzle onto a recording medium to conduct recording.

Then, as a drop ejection state detection device for detecting a state of drop ejection from a recording head, there is a technique of a forward scattered light method that emits a laser light from one side of a nozzle sequence of a recording head along the nozzle sequence and arranges, on the other side, light-receiving means for receiving scattered light from a liquid drop at a position displaced from a light axis of a light beam, so that the presence or absence of drop ejection is detected.

In a line-type image formation apparatus using a line-type head that forms an image by ejecting a liquid drop on a condition that a recording head is not moved, detection of ejection from at least two adjacent nozzle sequences is conducted by one light beam from one of light-emitting means, wherein it is necessary to increase a beam diameter in order to pass the beam through the two sequences and it is necessary to increase an amount of light emission in order to increase an amount of light incident on each nozzle. Furthermore, as a line width is increased, a distance from light-emitting means to light-receiving means is increased and thereby a displacement of a light axis due to an inclination is increased. As a result, scattered light is not provided in a case where a beam does not pass through a beam, and thereby, it is not possible to conduct detection of scattered light.

Furthermore, it is not possible to conduct detection of scattered light due to saturation in a detection circuit that is caused by an increase of an amount of offset light as a beam enters light-receiving means or the like. Furthermore, mechanical means for adjustment of a position or an inclination of a light axis are needed, so that cost is increased and accordingly it is not possible to be installed. Furthermore, there is a problem in such a manner that it is necessary to increase light-emitting means in a case where a head sequence is increased.

Japanese Patent Application Publication No. 2012-218420 discloses a configuration provided with head movement means for relatively moving a recording head in a direction intersecting with a light axis of a beam and means for adjusting the deflection angles in a direction intersecting with a light axis and a horizontal direction, for a purpose of increasing a precision of positioning of a nozzle sequence of a liquid ejection defect detection device and a light axis of a light beam.

Japanese Patent Application Publication No. 2012-035522 discloses a configuration provided with means for adjusting a light axis of a beam and a height of a light-receiving element and means for adjusting an amount of light of a light beam irradiating from a light-emitting element, for a purpose of readily conducing, at low cost, adjustment of an output from a liquid ejection defect detection device for detecting a liquid ejection state of an ink liquid drop.

However, in a technique disclosed in Japanese Patent Application No. 2012-218420, there is a problem that cost is increased because means for adjusting the deflection angles in a direction intersecting with a light axis and a horizontal direction are provided to adjust the angles.

Furthermore, because the number of nozzles is greater or a nozzle separation is greater, an amount of light incident on an ink liquid drop is reduced due to a diffraction effect in a case where a distance from a light-emitting element to a nozzle is increased, and thereby, there is a problem that an amount of scattered light from an ink liquid drop is reduced and it is not possible to detect a defect of ejection of a liquid drop accurately.

Furthermore, in a case where an energy density of a light beam does not conform to a light axis due to a characteristic of a light-emitting element, diffraction, or the like, there is a problem that a distance between a nozzle sequence and a light-receiving element at horizontal positions is increased to reduce an amount of scattered light incident on the light-receiving element and it is not possible to detect a defect of ejection of a liquid drop accurately.

Moreover, in a technique disclosed in Japanese Patent Application Publication No. 2012-035522, there is a problem that an amount of light incident on each ink liquid drop varies due to an inclination of a light-emitting element or a change in a nozzle separation between nozzle sequences.

### SUMMARY OF THE INVENTION

According to one aspect of the present invention, there is provided a liquid drop ejection state detection device, including a plurality of nozzle sequences configured to have a plurality of nozzles, a light-emitting element configured to emit a light beam incident on a liquid drop from each nozzle of each nozzle sequence, a light-receiving element provided at a position outside a beam diameter of the light beam and configured to receive scattered light from the liquid drop and detect an ejection state of the liquid drop based on an amount of the scattered light, a light-emitting element movement part configured to move the light-emitting element in a direction intersecting with a light axis of the light beam, and an adjustment part configured to adjust an amount of light of the light beam emitted from the light-emitting element.

According to another aspect of the present invention, there is provided an image formation apparatus, including a recording medium conveyance part configured to convey a recording medium, and the liquid drop ejection state detection device as described above, wherein the liquid drop ejection state detection device detects an ejection state of the liquid drop onto the recording medium.

### BRIEF DESCRIPTION OF THE DRAWINGS

FIG. 1 is a schematic diagram of a liquid ejection recording type image formation apparatus according to the present embodiment.

FIG. 2A, FIG. 2B, and FIG. 2C are schematic diagrams of a liquid drop ejection state detection device according to a first embodiment.

FIG. 3 is a diagram illustrating an ink jet head according to the present embodiment.

FIG. 4 is a diagram illustrating a relationship between an angle θ1 between a light receiving element and a light axis and an output voltage V of the light-receiving element.

FIG. 5A and FIG. 5B are diagrams illustrating a relationship between an intensity distribution of a light beam and a position of an ink liquid drop.

FIG. 6 is a diagram illustrating a relationship between the angle θ1 and scattered light from an ink liquid drop.

FIG. 7A and FIG. 7B are diagrams illustrating a relationship between an intensity distribution of a light beam and a position of an ink liquid drop.

FIG. 8 is a diagram illustrating a relationship between the angle θ1 and scattered light from an ink liquid drop.

FIG. 9A, FIG. 9B, and FIG. 9C are schematic diagrams illustrating a liquid drop ejection state detection device according to a second embodiment.

FIG. 10 is a diagram illustrating a relationship between an angle θ3 between a light receiving element and a light axis of a light beam and an output voltage V of the light-receiving element.

FIG. 11A, FIG. 11B, and FIG. 11C are schematic diagrams illustrating a liquid drop ejection state detection device according to a third embodiment.

FIG. 12A, FIG. 12B, and FIG. 12C are schematic diagrams illustrating a liquid drop ejection state detection device according to a fourth embodiment.

FIG. 13A, FIG. 13B, and FIG. 13C are schematic diagrams illustrating a liquid drop ejection state detection device according to a fifth embodiment.

FIG. 14A, FIG. 14B, and FIG. 14C are schematic diagrams illustrating a liquid drop ejection state detection device according to a sixth embodiment.

FIG. 15 is a diagram illustrating an example in such a manner that a plurality of sets of a wavelength filter and a light-receiving element that are arranged in one light-blocking cylinder are juxtaposed and arranged in a periphery of a light beam.

FIG. 16 is a diagram illustrating an example in such a manner that a plurality of sets of a wavelength filter and a light-receiving element are juxtaposed and arranged in one light-blocking cylinder.

FIG. 17 is a diagram illustrating an example in such a manner that a wavelength filter and a light-receiving element are placed in one light-blocking cylinder.

### DETAILED DESCRIPTION OF THE PREFERRED EMBODIMENTS

The present embodiments will be described with reference to the drawings in more detail below.

### First Embodiment

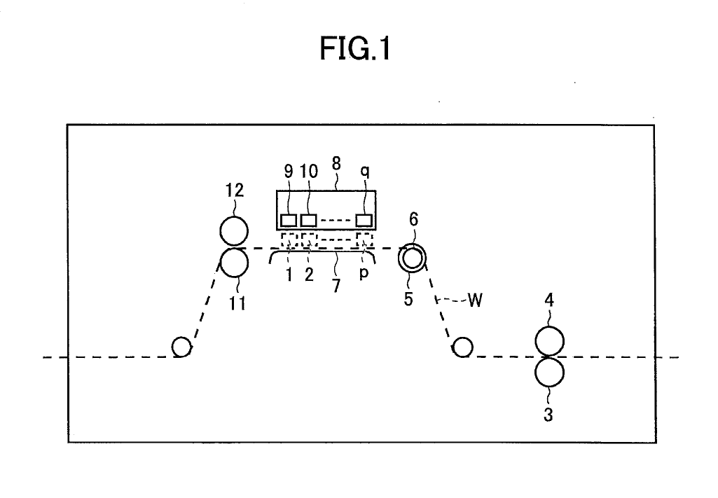

FIG. 1 is a schematic diagram of a liquid ejection recording type image formation apparatus according to the present embodiment. 1, 2, . . . p indicated by dotted lines indicate liquid drop ejection state detection devices in the present embodiment(s).

A recording medium W is conveyed by a paper feeding conveyance roller 3 coupled to a (not-illustrated) paper feeding motor and a paper feeding conveyance driven roller 4 from a paper feeding part onto a driven roller 6 that is provided with a recording medium feed amount detection encoder 5 for outputting a detection signal depending on movement of a recording medium at a predetermined distance (that will be abbreviated as an “encoder” below) and is drive for conveyance of the recording medium, and then conveyed to a transit plate 7. Ink drop ejection onto the recording medium W is conducted by ink-jet heads 9, 10, . . . q of an ink-jet head array 8 that is present at a position opposing the transit plate 7.

Subsequently, the recording medium W conveyed on the transit plate 7 is conveyed by a paper ejection conveyance roller 11 coupled to a (not-illustrated) paper ejection motor and a paper ejection conveyance driven roller 12 and ejected to the exterior of such an ink-jet-type printing apparatus. Here, the encoder 5 is installed between the paper feeding conveyance roller 3 and the transit plate 7 but may be installed between the transit plate 7 and the paper ejection conveyance roller 11.

Here, a liquid ejection recording type “image formation apparatus” means an apparatus that lands an ink onto a paper, thread, fiber, cloth, leather, metal, plastic, glass, wood, or ceramic medium or the like, so as to conduct image formation, and “image formation” means not only applying a meaningful image such as a character or figure onto a medium but also applying a meaningless image such as a pattern onto a medium (simply landing a liquid drop onto a medium).

Furthermore, an “ink” is not limited to one referred to as an ink and is used as a generic term for all of liquids that are capable of conducting image formation, such as one referred to as a recording liquid, a fixing process liquid, a resin, a liquid, or the like. Furthermore, a “paper sheet” is not limited to a paper material, includes an OHP sheet, a cloth, or the like, as described above, means one with an ink drop being attached thereto, and is used as a generic term for those including one referred to as a medium to be recorded, a recording medium, a recording paper, a recording paper sheet, or the like. Furthermore, an “image” is not limited to a planar one but also includes an image applied to a stereographically formed one and further an image formed by three-dimensionally shaping a solid per se.

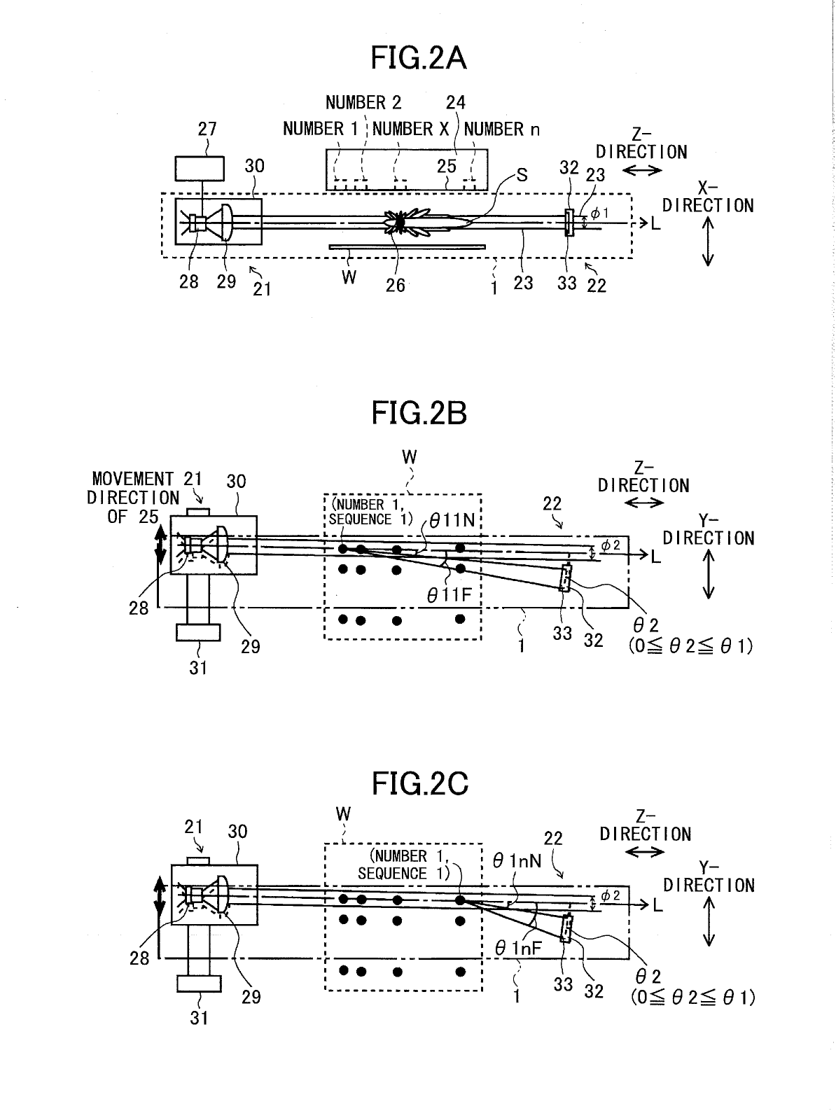

FIG. 2A, FIG. 2B, and FIG. 2C are schematic diagrams of a liquid drop ejection state detection device according to a first embodiment. A liquid drop ejection state detection device 1 in the present embodiment is provided with a light-emitting part 21 and a light-receiving part 22. As illustrated in FIG. 2A, the light-emitting part 21 and the light-receiving part 22 are arranged at positions in such a manner that a light axis L of a light beam 23 is provided in a direction perpendicular to an ink liquid drop 26 ejected from a nozzle (1, 2, . . . n) on a head nozzle surface 25 of an ink-jet head 24. A light emission driving part 27 sets an amount of light emission. A movement mechanism 31 is placed for moving a light-emitting unit 30 with a light-emitting element 28 and a collimator lens 29 mounted thereon.

FIG. 2B illustrates a view of a case where a light beam is targeted at a first nozzle in a first column, when viewed from an upper side of FIG. 2A, and FIG. 2C illustrates a view of a case where a light beam is targeted at nozzle (number n, sequence 1), when viewed from an upper side of FIG. 2A. Arrangement is made at a position in such a manner that the light axis L of the light beam 23 is provided at an angle θ2 (0°≦θ2<360°) with respect to a direction of conveyance of a recording medium W.

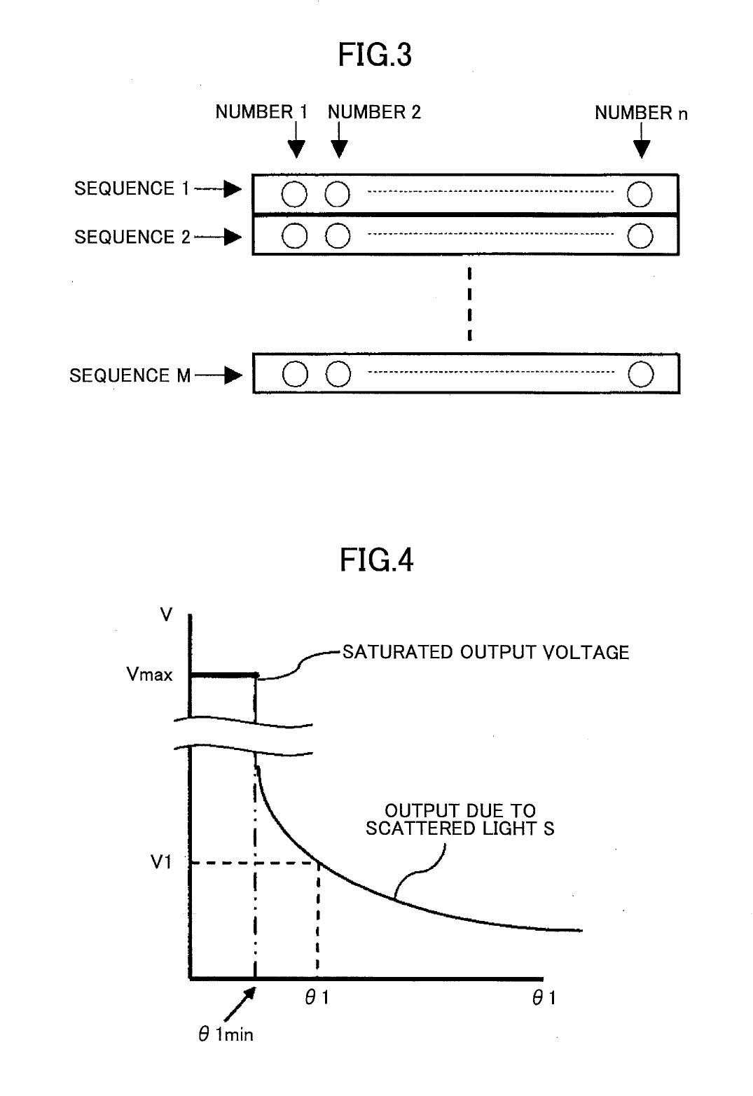

FIG. 3 is a view of the ink-jet head 24 according to the present embodiment when viewed from an upper side of FIG. 2A. Nozzles on the head nozzle surface 25 of the ink-jet head 24 are composed of M nozzle sequences (1, 2, . . . M) and each sequence is composed of n nozzles (1, 2, . . . n).

The light-emitting part 21 is configured to include the light-emitting element 28 configured to use a semiconductor laser that emits a light beam and the collimator lens 29 that narrows the light beam emitted from the light-emitting element 28 into collimated light to provide the light beam 23 with beam diameters φ1 and φ2. φ1 and φ2 indicate a longitudinal diameter and a transverse diameter in beam diameters. Here, the light-emitting element 28 is not limited to a semiconductor laser and it is also possible to be configured to use, for example, a light emitting diode (LED) or the like. The light-emitting element 28 and the collimator lens 29 are mounted on the light-emitting unit 30.

Which of φ1 and φ2 is a longitudinal diameter or whether φ1=φ2 depends on a condition such as a wavelength and an intensity distribution of a light beam, a separation between respective sequences, a shape and a size of a liquid drop, a kind and a radiation angle of a light-emitting element, a separation between a light-emitting element and a collimator lens, a separation between a light-emitting element and a liquid drop, a separation between a liquid drop and a light-receiving element, a position and a size of a light-receiving element, or a separation between a head and a printing medium.

The movement mechanism 31 moves a light beam emitted from the light-emitting unit 30 to be positioned in such a manner that an ink liquid drop ejected from each nozzle is irradiated therewith.

The light-receiving part 22 is configured to include a light-receiving element 32 that uses a photodiode or the like. The light-receiving part 22 is arranged at a position displaced from the beam diameter φ2 of the light beam 23 so that a light-receiving surface 33 of the light-receiving element 32 is not provided within the beam diameter φ2 of the light beam 23. However, it is preferable to arrange the light-receiving part 22 at a position adjacent to the beam diameter φ2. The light-receiving part 22 is arranged at a position to be inclined at an angle θ1 with respect to the light axis L of the light beam 23 and a position to have an angle θ2 (0≦θ2≦θ1) with respect to a direction perpendicular to the light axis L.

θ11N and θ11F indicate an angle of number 1 in sequence 1 with respect an end face of the light-receiving element 32 near a side of sequence 1 and an angle of number 1 in sequence 1 with respect to an end face of the light-emitting element 32 far from a side of sequence 1. θ1nN and θ1nF indicate an angle of number n in sequence 1 with respect an end face of the light-receiving element 32 near a side of sequence 1 and an angle of number n in sequence 1 with respect to an end face of the light-emitting element 32 far from a side of sequence 1.

In an image formation apparatus according to the present embodiment, the ink liquid drop 26 is ejected from each nozzle (number 1 in sequence 1, number 2 in sequence 1, . . . number n in sequence 1, number 1 in sequence 2, number 2 in sequence 2, . . . number n in sequence 2, . . . , number 1 in sequence M, number 2 in sequence M, . . . number n in sequence M) on the head nozzle surface 25 of the ink-jet head 24 and the light beam 23 impinges on such an ink liquid drop 26 so that scattered light S is generated.

The liquid drop ejection state detection device 1 according to the present embodiment, an amount of received light obtained by reaching the light-receiving surface 33 of the light-emitting element 32 in the aforementioned generated scattered light S is light-to-voltage-converted by the light-receiving element 32 and such light-to-voltage-converted output voltage V is measured to obtain data of light-receiving of the scattered light S. Based on such data of light-receiving, a liquid drop ejection state such as presence or absence of ejection of the ink liquid drop 26 or a displacement of ejection of the ink liquid drop 26 is detected.

FIG. 4 is a diagram illustrating a relationship between an angle θ1 between the light-receiving element 32 and the light axis L of the light beams 23 and an output voltage V of the light-receiving element 32. In FIG. 4, a transverse axis indicates the angle θ1 between the light-receiving element 32 and the light axis L and a longitudinal axis indicates the output voltage V of the light-receiving element 32. As illustrated in FIG. 4, the output voltage V due to the scattered light S has an angular dependence wherein the output voltage V due to the scattered light S is decreased as θ1 is increased.

However, it is not possible to detect the scattered light S at θ1≦θ1 min, because a saturated sate of Vmax is provided even on a condition that the ink liquid drop 26 is not ejected, due to the following reason (1) or (2). θ1min is a minimum angle between the light-receiving element 32 and the light axis L on the condition of (1) or (2). (1) is a case where the light-receiving element 32 is provided within the beam diameter φ1 of the light beam 23.

Furthermore, (2) is a case where the light-receiving element 32 is provided at a position in such a manner that an amount of light received by the light-receiving element 32 is greater than or equal to a threshold value of offset light. Because peripheral light of a light beam is present outside of the beam diameter φ1 and further light reflected from a recording medium W, the ink-jet head 24, another peripheral component, or the like, or the like is provided (that will all be referred to as “offset light” below), offset light is incident on the light-receiving element 32.

As such offset light is increased, the output voltage V of the light-receiving element 32 is a saturated state of Vmax even on a condition that the ink liquid drop 26 is not ejected, so that it is not possible to detect the scattered light S. A value of offset light at this case is a threshold value of offset light.

Accordingly, an angle θ1 between the light-receiving element 32 and the light axis L is necessarily θ1>θ1min. Although a downward-sloping curve with respect to an angle θ is illustrated in FIG. 4, a downward-sloping curve with a waveform may be provided depending on a shape or a size of a liquid drop.

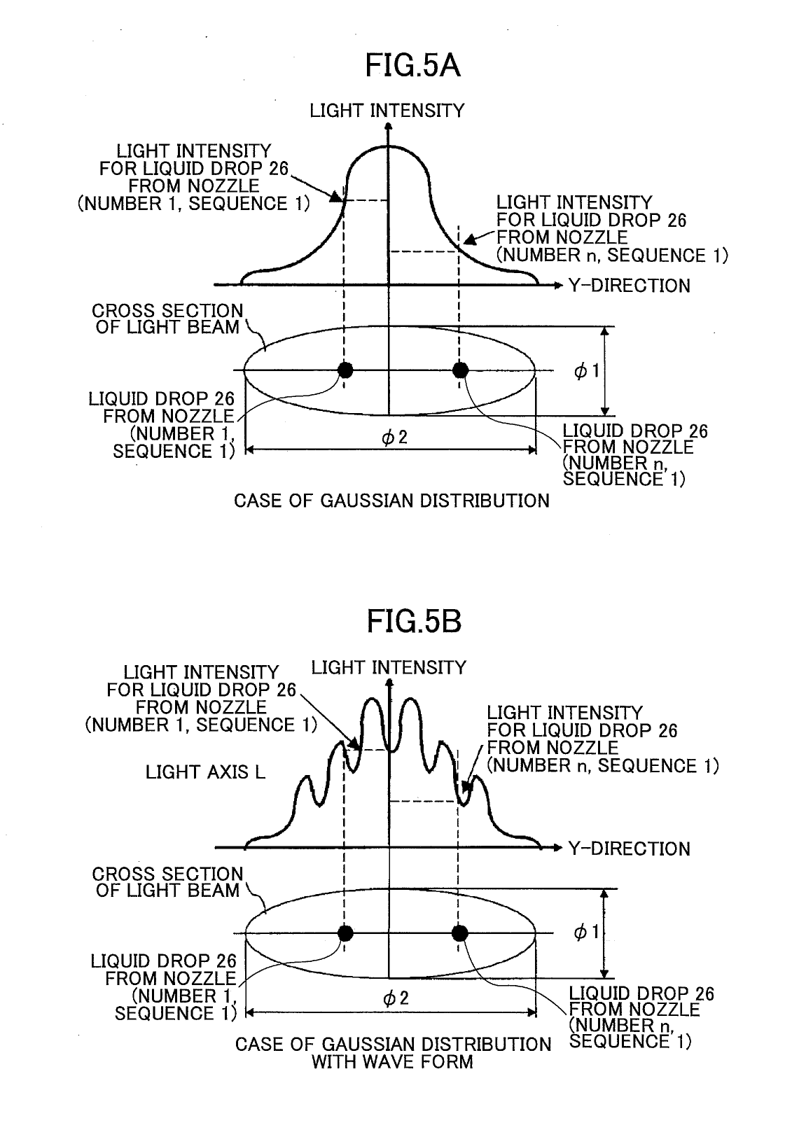

FIG. 5A and FIG. 5B are diagrams illustrating a relationship between an intensity distribution of a light beam and a position of an ink liquid drop. FIG. 5A illustrates a case of a Gaussian distribution and FIG. 5B illustrates a case of a Gaussian distribution with a waveform. An upper figure illustrates an intensity distribution of a light beam, wherein a transverse axis is in a Y-direction and a longitudinal axis is a light intensity. A lower figure illustrates a cross section of a light beam. Here, FIG. 5A and FIG. 5B are one example of intensity distributions. As illustrated in the figures, a light intensity varies in a Y-direction.

Furthermore, a light intensity distribution is changed depending on a characteristic or a position of each of a light-emitting element, a collimator lens, and a narrowing member described below, a distance from a light-emitting element or a collimator lens to an ink liquid drop (in a Z-direction), or the like. Accordingly, a position on an intensity distribution is changed depending on a position in a Y-direction with respect to a position of the ink liquid drop 26 ejected from each nozzle and a distance from a light-emitting element or a collimator lens to an ink liquid drop (in a Z-direction) is changed, so that a light intensity on the ink liquid drop 26 ejected from each nozzle is changed.

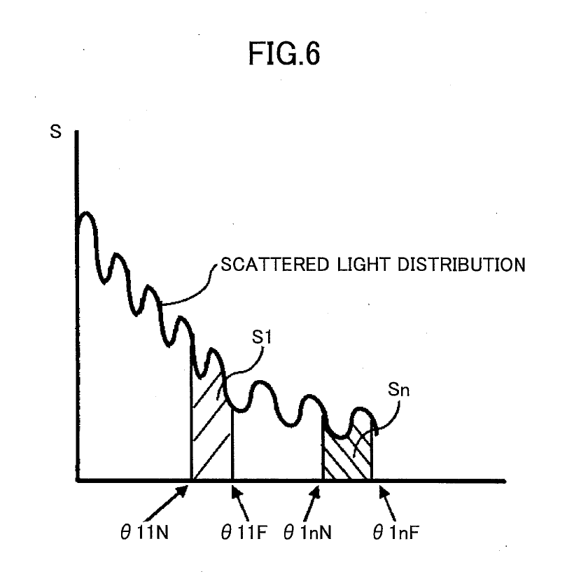

FIG. 6 is a diagram illustrating a relationship between the angle θ1 and scattered light from an ink liquid drop (X=0). Scattered light from an ink liquid drop is provided with a waveform distribution having an angular dependency. A damping rate of a waveform, a height of an amplitude, or a width of an amplitude is changed depending on a wavelength of light incident on an ink liquid drop or a component, a shape, or a size of an ink liquid drop.

An incident angle from an ink liquid drop ejected from nozzle (number 1, sequence 1) to the light-receiving element 32 is in a range of θ11N-θ11F and S1 is an amount of received light incident on the light-receiving element 32. An incident angle from an ink liquid drop ejected from nozzle (number n, sequence 1) to the light-receiving element 32 is in a range of θ1nN-θ1nF and Sn is an amount of received light incident on the light-receiving element 32. An incident angle is determined by positions of light incident on an ink liquid drop and a light-receiving surface of a light-receiving element or a shape or a size of a light-receiving surface of a light-receiving element.

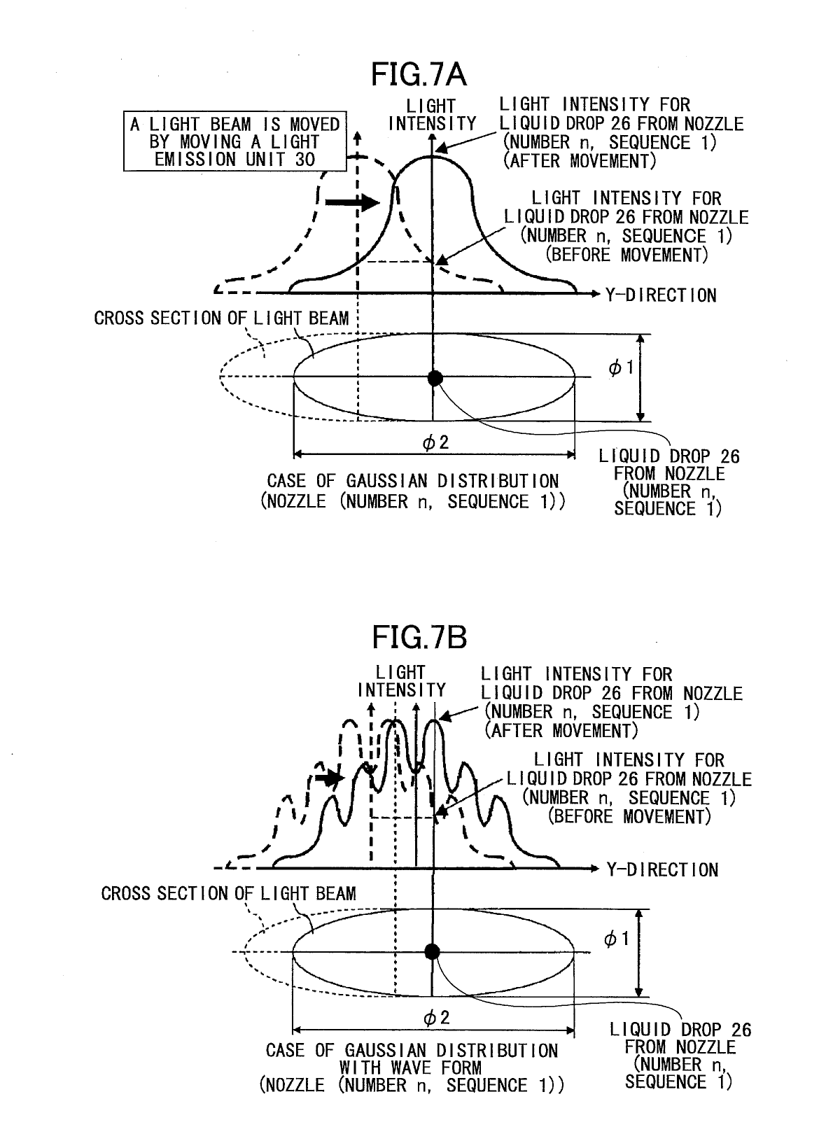

FIG. 7A and FIG. 7B are diagrams illustrating a relationship between an intensity distribution of a light beam and a position of an ink liquid drop. FIG. 7A illustrates a case of a Gaussian distribution (nozzle (number n, sequence 1)) and FIG. 7B illustrates a case of a Gaussian distribution with a waveform (nozzle (number n, sequence 1)). An upper figure illustrates an intensity distribution of a light beam, wherein a transverse axis is in a Y-direction and a longitudinal axis is a light intensity. A lower figure illustrates a cross section of a light beam. Here, FIG. 7A and FIG. 7B are one example of intensity distributions.

A light intensity varies in a Y-direction. Furthermore, a light intensity distribution is changed depending on a characteristic or a position of each of a light-emitting element, a collimator lens, and a narrowing member described below, a distance from a light-emitting element or a collimator lens to an ink liquid drop (in a Z-direction), or the like.

Accordingly, a position on an intensity distribution is changed depending on a position in a Y-direction with respect to a position of the ink liquid drop 26 ejected from each nozzle and a distance from a light-emitting element or a collimator lens to an ink liquid drop (in a Z-direction) is changed, so that a light intensity on the ink liquid drop 26 ejected from each nozzle is changed.

In the present embodiment, the light-emitting unit 30 is moved and thereby a light axis of a light beam is moved to an optimum position to irradiate a liquid drop 26 from each nozzle, so that an amount of a light beam incident on a liquid drop 26 from each nozzle is set at an optimum value. Usually, a light axis of a light beam is moved to a position of a center of a liquid drop 26 from each nozzle so that an amount of a light beam incident on a liquid drop 26 from each nozzle is increased.

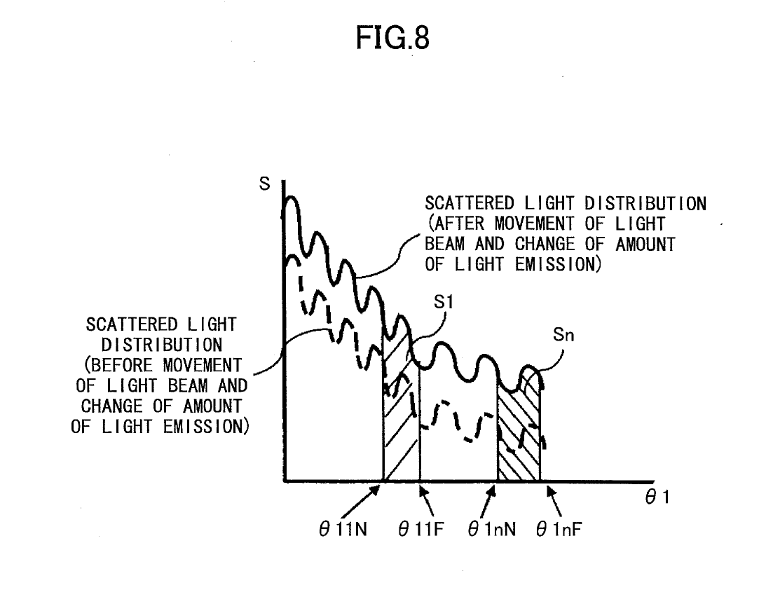

FIG. 8 is a diagram illustrating a relationship between the angle θ1 and scattered light from an ink liquid drop (X=0). Scattered light from an ink liquid drop is provided with a waveform distribution having an angular dependency. A damping rate of a waveform, a height of an amplitude, or a width of an amplitude is changed depending on a wavelength of light incident on an ink liquid drop or a component, a shape, or a size of an ink liquid drop.

An incident angle from an ink liquid drop ejected from nozzle (number 1, sequence 1) to the light-receiving element 32 is in a range of θ11N-θ11F and S1 is an amount of received light incident on the light-receiving element 32. An incident angle from an ink liquid drop ejected from nozzle 1n to the light-receiving element 32 is in a range of θ1nN-θ1nF and Sn is an amount of received light incident on the light-receiving element 32. An incident angle is determined by positions of light incident on an ink liquid drop and a light-receiving surface of a light-receiving element or a shape or a size of a light-receiving surface of a light-receiving element.

A solid line in FIG. 8 indicates a scattered light distribution after moving the light-emitting unit 30 so that a light axis of a light beam is moved to an optimum position to irradiate a liquid drop 26 from each nozzle and setting an amount of light emission of the light-emitting element 28 at an optimum value by the light emission driving part 27 for setting an amount of light emission, and a broken line indicates a scattered light distribution before the setting.

An amount of received light is obtained from an amount of light incident on an ink liquid drop α, a rate of an amount of scattered light β (an amount of scattered light/an amount of incident light), and a rate of incidence on a light-receiving element γ (an amount of scattered light incident on a light-receiving element/an amount of entire scattered light), by an amount of received light=an amount of light incident on an ink liquid drop α×a rate of an amount of scattered light β×a rate of incidence on a light-receiving element γ.

An amount of light incident on an ink liquid drop α at a position of each nozzle is determined by an amount of light emission A, an intensity distribution of a light beam at a position for being incident on an ink liquid drop B, a position of an ink liquid drop in an intensity distribution C, a shape of a liquid drop D, a component of a liquid drop E, or the like. An amount of light emission A is controllable and it is possible to set an amount of light emission at a position of each nozzle.

Because an intensity distribution of a light beam at a position for being incident on an ink liquid drop B is changed depending on diffraction determined by a characteristic of a light-emitting element, characteristics of or a separation among a light-emitting element, a collimator lens, and a narrowing member described below, or a distance from a collimator lens to an ink liquid drop, it is not possible to set an identical intensity distribution at a position of each nozzle.

Because a position of an ink liquid drop in an intensity distribution C is determined by a light beam and a position of a nozzle, it is possible to be controlled by moving a horizontal position of a light-emitting element and it is possible to set a position of an ink liquid drop and an intensity distribution of a light beam at optimum positions with respect to a position of each nozzle.

Because a shape of a liquid drop D is determined by a characteristic of a nozzle or a driving circuit and a shape (size) of a liquid drop is arbitrarily set at an optimum shape (size) to improve an image quality, it is not possible to set an identical shape of a liquid drop at a position of each nozzle.

Because a component of a liquid drop E is changed by an ink to be used, it is not possible to set an identical component of a liquid drop in a case where a different ink is used at a position of each nozzle. Hence, it is possible to set an amount of light incident on an ink liquid drop α for each nozzle at an arbitrary value by controlling an amount of light emission A of a light-emitting element or a position of an ink liquid drop in an intensity distribution C.

A rate of an amount of scattered light β at a position of each nozzle is defined as an amount of scattered light/an amount of incident light and is determined by a shape of a liquid drop D, a component of a liquid drop E, a wavelength of a light beam F, or the like. It is possible to control a wavelength of a light beam F by using an identical light beam. However, it is not possible to set a rate of an amount of scattered light β at an arbitrary value, because it is not possible to set an identical shape of a liquid drop D as mentioned above.

A rate of incidence on a light-receiving element γ at a position of each nozzle is defined as an amount of scattered light incident on a light-receiving element/an amount of entire scattered light, wherein an amount of scattered light has a high angular dependency and is determined by an amount of light emission A, an intensity distribution of a light beam at a position for being incident on an ink liquid drop B, a position of an ink liquid drop in an intensity distribution C, a shape of a liquid drop D, a component of a liquid drop E, or an angle between a light beam and a light-receiving element G. It is not possible to set a rate of incidence on a light-receiving element γ at an arbitrary value, because it is not possible to provide an identical angle between a light beam and a light-receiving element G or the like.

In the present embodiment, an amount of light emission of the light-emitting element 28 is set at an optimum value by the light emission driving part 27 for setting an amount of light emission and the light-emitting unit 30 with the light-emitting element 28 and the collimator lens 28 mounted thereon is moved by the movement mechanism 31 for moving the light-emitting unit 30 to set a position of an ink liquid drop and an intensity distribution of a light beam at optimum positions, so that an amount of light incident on the ink liquid drop 26 α for each nozzle is changed to set an amount of received light incident on the light-receiving element 32 at an optimum value. Usually, a position for a maximum amount of light of a light beam is moved to a position of a center of a liquid drop 26 for each nozzle so that an amount of light incident on the ink liquid drop 26 α for each nozzle is increased.

### Second Embodiment

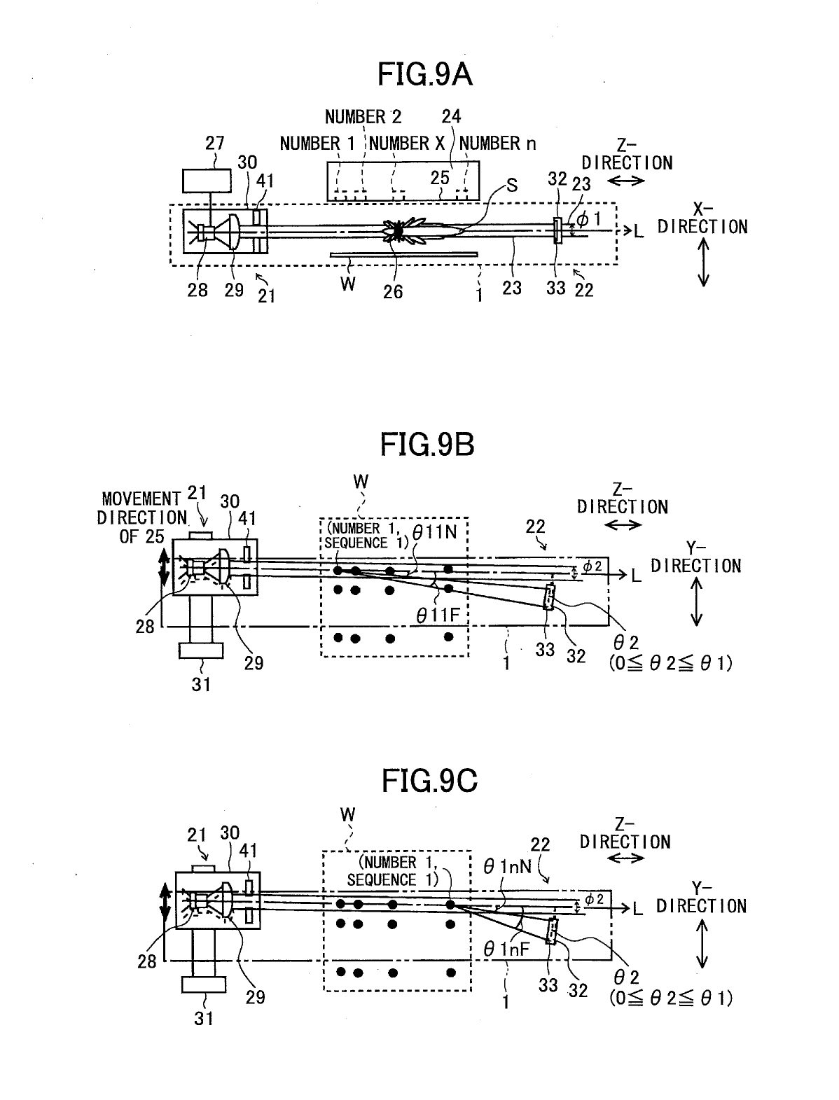

FIG. 9A, FIG. 9B, and FIG. 9C are schematic diagrams illustrating a liquid drop ejection state detection device according to a second embodiment. A liquid drop ejection state detection device according to the present embodiment is such that a narrowing member 41 for narrowing the light beam 23 emitted from the light-emitting element 28 is placed at a downstream side of the collimator lens 29 in a direction of the light beam 23 in the device according to the first embodiment. The light-emitting element 28, the collimator lens 29, and the narrowing member 41 are mounted on the light-emitting unit 30.

For the narrowing member 41, it is possible to provide, for example, an aperture, a slit, or the like. The narrowing member 41 is mounted in such a configuration example of the first embodiment so that the light beam 23 emitted from the light-emitting element 28 is narrowed by the narrowing member 41, and thereby, it is possible to reduce beam diameters φ4 and φ3 of the light beam 23 (φ4<φ2 and φ3<φ1). φ4 and φ3 indicate a longitudinal diameter and a transverse diameter in beam diameters. As a result, it is possible to provide an angle θ3 between the light-receiving element 32 and the light axis L that is smaller than θ1 in the first embodiment.

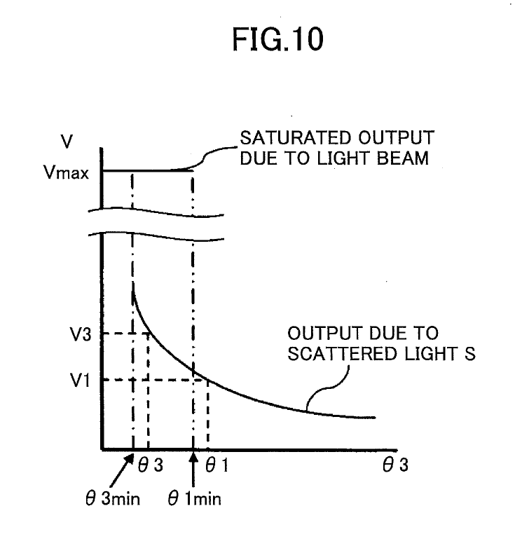

FIG. 10 is a diagram illustrating a relationship between angle θ3 between the light-emitting element 32 and the light axis L of the light beam 23 and an output voltage V of the light-receiving element 32. In FIG. 10, a transverse axis indicates angle θ3 between the light-emitting element 32 and the light axis L, and a longitudinal axis indicates an output voltage V of the light-receiving element 32.

An output voltage V due to scattered light S has an angular dependency, wherein an output voltage V due to scattered light S is decreased as the angle θ3 is increased. Accordingly, an amount of received light due to scattered light S is increased on a condition that the angle θ3 is in θ3<θ1, and an output voltage V3 that is light-to-voltage-converted by the light-receiving element 32 is in V1 (an output voltage at θ1)<V3 (an output voltage at θ3).

Furthermore, the light beam 23 emitted from the light-emitting element 28 is narrowed to suppress a dispersion of a light intensity of the light beam 23 emitted from the light-emitting element 28, a distortion of a wave front thereof, or the like, and thereby, scattered light S generated by irradiating the ink liquid drop 26 with the light beam 23 is also scattered light S with a dispersion of a light intensity, a distortion of a wave front, or the like being suppressed.

Hence, it is possible to reduce an angle between the light-receiving element 32 and a light axis of the light beam 23 because beam diameters of the light beam 23 is reduced by the narrowing member 41. Thereby, an amount of light at the light-receiving element 23 that is scattered light S generated from the light beam 23 incident on an ink liquid drop at a time of ink ejection is increased with respect to an amount of received light at the light-receiving element 32 due to reflected light of the light beam 23 at a recording medium, a liquid drop ejection head, or the like, or noise light N such as disturbance light, and accordingly, an S/N ratio is increased so that detection of a defect of ink ejection is ensured.

Furthermore, it is possible to reduce an influence of aberration at a peripheral portion of the light beam 23 from the light-emitting element 28 or a peripheral portion of a lens, and hence, a dispersion of a light intensity of the light beam 23, a distortion of a wave front thereof, or the like is suppressed so that a dispersion of a light intensity, a distortion of a wave front, or the like is also suppressed for scattered light generated by a light beam incident on a liquid drop. Accordingly, a dispersion, a change, or the like, of an amount of received light on the light-receiving element 32 is suppressed, and precision of detection is improved so that detection of a defect of ink ejection is ensured.

### Third Embodiment

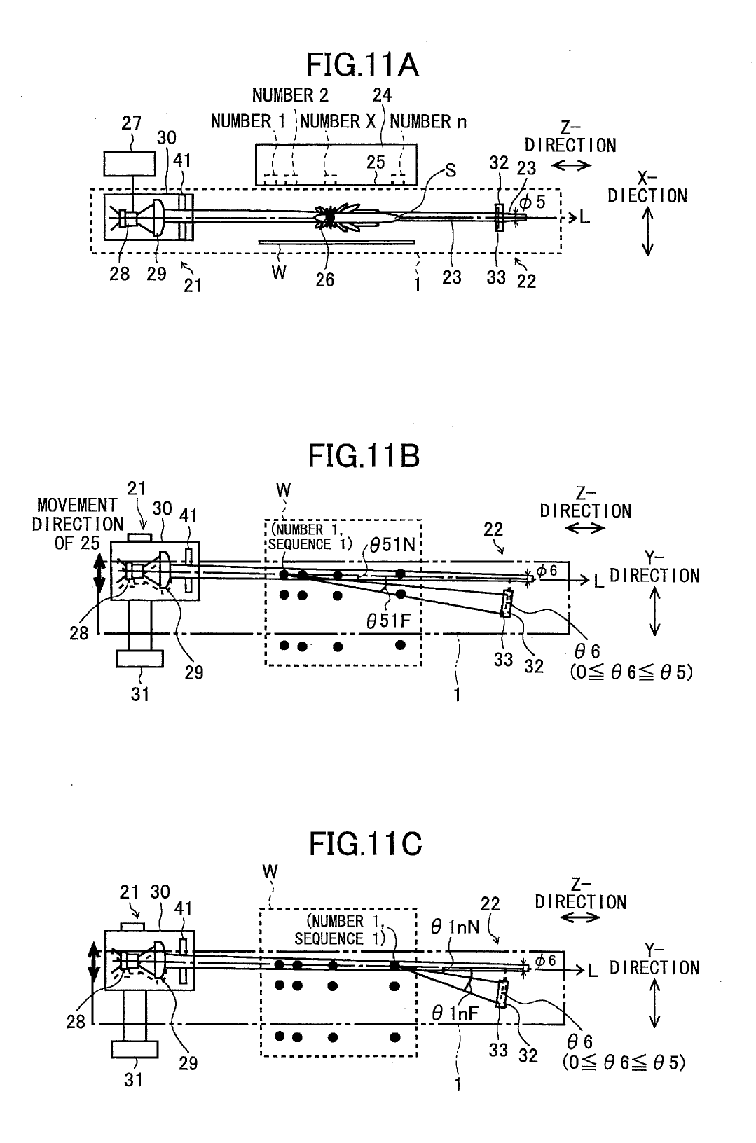

FIG. 11A, FIG. 11B, and FIG. 11C are schematic diagrams illustrating a liquid drop ejection state detection device according to a third embodiment. A liquid drop ejection state detection device according to the present embodiment is such that a light beam in the first or second embodiment is changed from collimated light to convergent light.

As described above, an amount of received light is obtained by an amount of received light=an amount of light incident on an ink liquid drop×a rate of an amount of scattered light×a rate of incidence on a light-receiving element. In a case of collimated light, an intensity distribution of a light beam is broadened due to an influence of diffraction as travelling from nozzle (number 1, sequence 1) near a light-emitting element to nozzle (number n, sequence 1) far from the light-emitting element, and a maximum intensity of the beam is reduced. Accordingly, an amount of light emission of a light-emitting element is increased and the light-emitting element is moved by light-emitting element movement means, so that a position of an ink liquid drop and an intensity distribution of a light beam are set at optimum positions.

As a light beam is changed from collimated light to convergent light, an amount of incident light is increased from at nozzle (number 1, sequence 1) to at nozzle (number n, sequence 1) more than a case of collimated light, and hence, it is possible to increase an amount of received light. As an amount of received light is increased, an S/N ratio of an amount of received light due to scattered light S to an amount of received light due to noise light N is increased, so that precision of detection is improved and detection of a defect of ink ejection is ensured.

Furthermore, as a rate of convergence is an optimum value, it is possible to provide a comparable amount of received light while an increase of an amount of light emission is suppressed. It is possible to reduce an amount of light emission with respect to a case of collimated light, so that it is possible to reduce a rated output of a light-emitting element and it is possible to reduce a risk level of the light-emitting element. Furthermore, it is also possible to expect an effect of cost reduction.

### Fourth Embodiment

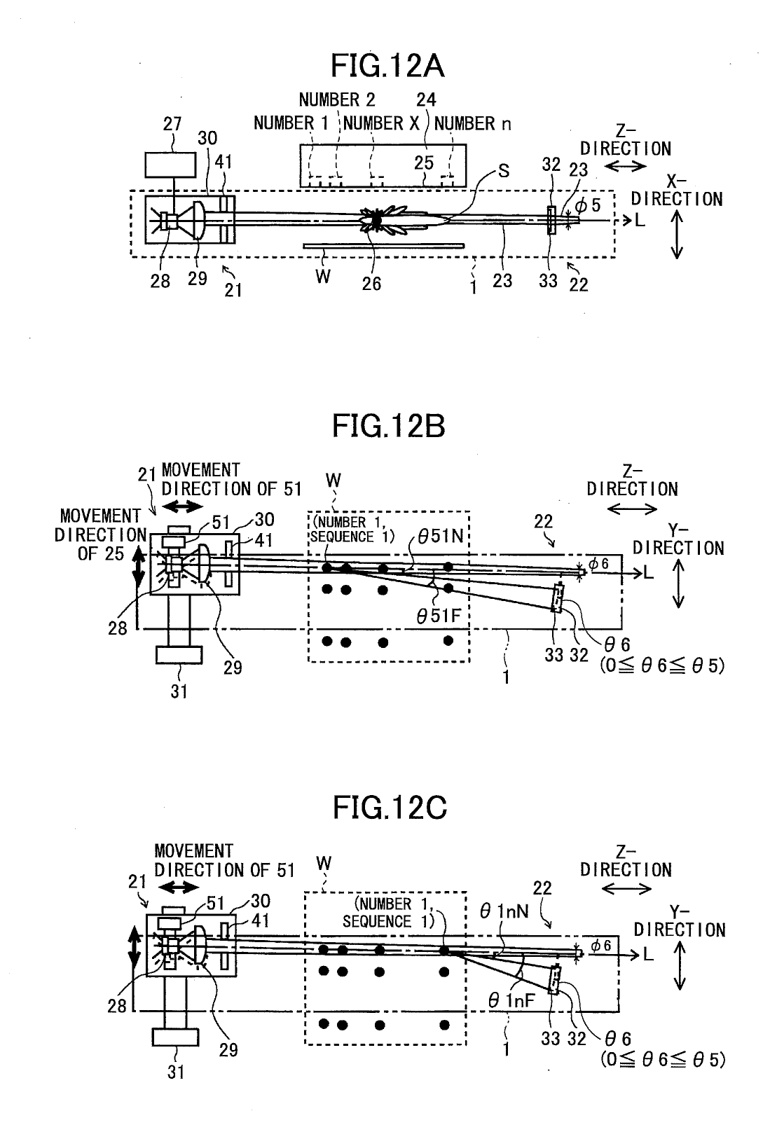

FIG. 12A, FIG. 12B, and FIG. 12C are schematic diagrams illustrating a liquid drop ejection state detection device according to a fourth embodiment. A liquid drop ejection state detection device according to the present embodiment is such that the device according to any of the first to third embodiments is provided with moving means 51 for the light-emitting element 28 in order to change a light beam from collimated light to convergent light. As described above, an amount of received light is obtained by an amount of received light=an amount of light incident on an ink liquid drop×a rate of an amount of scattered light×a rate of incidence on a light-receiving element.

Because it is possible to change a rate of convergence by being provided with the moving means 51 for a light-emitting element, a rate of convergence is set in such a manner that an amount of light incident on an ink liquid drop from nozzle (number 1, sequence 1) to nozzle (number n, sequence 1) is an optimum value.

As an amount of incident light for nozzle (number 1, sequence 1) to nozzle (number n, sequence 1) is set at an optimum value, an amount of received light is increased and an S/N ratio of an amount of received light due to scattered light S to an amount of received light due to noise light N is increased, so that precision of detection is improved and detection of a defect of ink ejection is ensured.

Furthermore, as a rate of convergence is an optimum value, it is possible to provide a comparable amount of received light while an increase of an amount of light emission is suppressed. It is possible to reduce an amount of light emission with respect to a case of collimated light, so that it is possible to reduce a rated output of a light-emitting element and it is possible to reduce a risk level of the light-emitting element. Furthermore, it is also possible to expect an effect of cost reduction.

### Fifth Embodiment

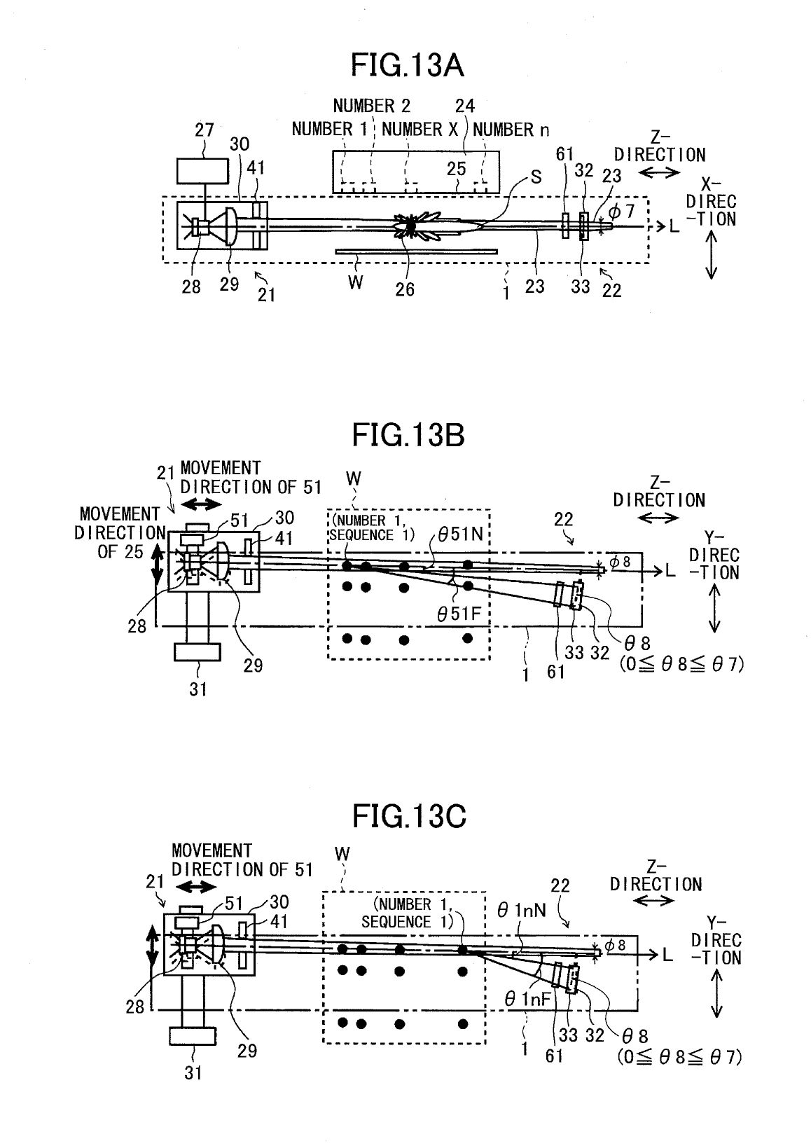

FIG. 13A, FIG. 13B, and FIG. 13C are schematic diagrams illustrating a liquid drop ejection state detection device according to a fifth embodiment. A liquid drop ejection state detection device according to the present embodiment is such that the device according to any of the first to fourth embodiments is provided with a wavelength filter 61 for transmitting only scattered light S with a wavelength identical to a wavelength of the light beam 23 emitted from the light-emitting element 28, at a front side of the light-receiving element 32.

Similarly to the light-receiving surface 33 of the light-receiving element 32, the wavelength filter 61 is arranged at a position displaced from a beam diameter φ8 of the light beam 23 so as not to be included in the beam diameter φ8 of the light beam 23. However, it is preferable for a light-receiving part B to be arranged at a position adjacent to a beam diameter φ8.

As the wavelength filter 61 is provided at a front side of the light-receiving element 32, nose light N such as disturbance light is prevented from approaching the light-receiving element 32 and an S/N ratio of an amount of received light due to scattered light S to an amount of received light due to noise light N is increased, so that detection of a defect of ink ejection is ensured.

Furthermore, as the light-emitting element 28 for emitting light beams 23 with different wavelengths and the wavelength filter 61 for transmitting only light with those wavelengths are placed in front of the light-receiving element 32 in a case where a configuration of at least two liquid drop ejection state detection devices for detecting drop ejection states is provided, scattered light from a liquid drop ejection state detection device for detecting an arbitrary ejection state does not transmit through the wavelength filter 61 of a liquid drop ejection state detection device for detecting another ejection state so as not to be incident on the light-receiving element 32 so that detection of a defect of ink ejection is ensured.

### Sixth Embodiment

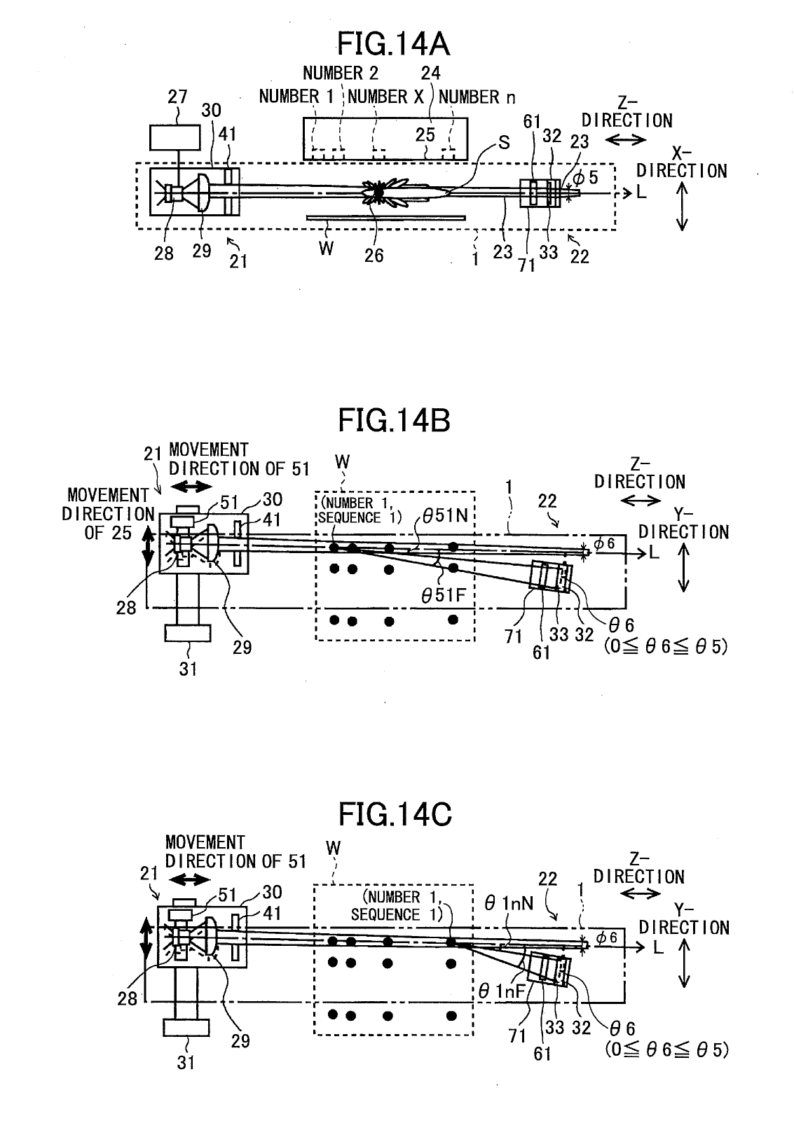

FIG. 14A, FIG. 14B, and FIG. 14C are schematic diagrams illustrating a liquid drop ejection state detection device according to a sixth embodiment. A liquid drop ejection state detection device according to the present embodiment is such that the device according to any of the first to fifth embodiments has a light-blocking cylinder 71 and the wavelength filter 61 and the light-receiving element 32 are arranged in one light-blocking cylinder 71.

As the wavelength filter 61 and the light-receiving element 32 are arranged in the one light-blocking cylinder 71, noise light N is prevented from approaching between the wavelength filter 61 and the light-receiving element 32 so that it is possible to reduce an amount of received light due to the noise light N.

As a result, the wavelength filter 61 and the light-receiving element 32 are arranged in the one light-blocking cylinder 71 to prevent noise light N such as reflected light of a light beam from a recording medium, a liquid drop ejection head, or the like, or disturbance light, from approaching between the wavelength filter and the light-receiving element, and an amount of received light on the light-receiving element due to scattered light S produced by a light beam being incident on an ink liquid drop at a time of ink ejection to an amount of light on the light-receiving element due to the noise light N is increased, so that an S/N ratio of an amount of received light due to the scattered light S to an amount of received light due to the noise light N is increased and detection of a defect of ink ejection is ensured.

Furthermore, it is preferable for the light-blocking cylinder 71 to extend to a side of the light-emitting element 28 with respect to the wavelength filter 61 as long as the light beam 23 is not directly incident on the light-blocking cylinder 71. Thereby, it is possible to further reduce approach of noise light N, so that an S/N ratio of an amount of received light due to the scattered light S to an amount of received light due to the noise light N is further increased and detection of a defect of ink ejection is ensured.

### Seventh Embodiment

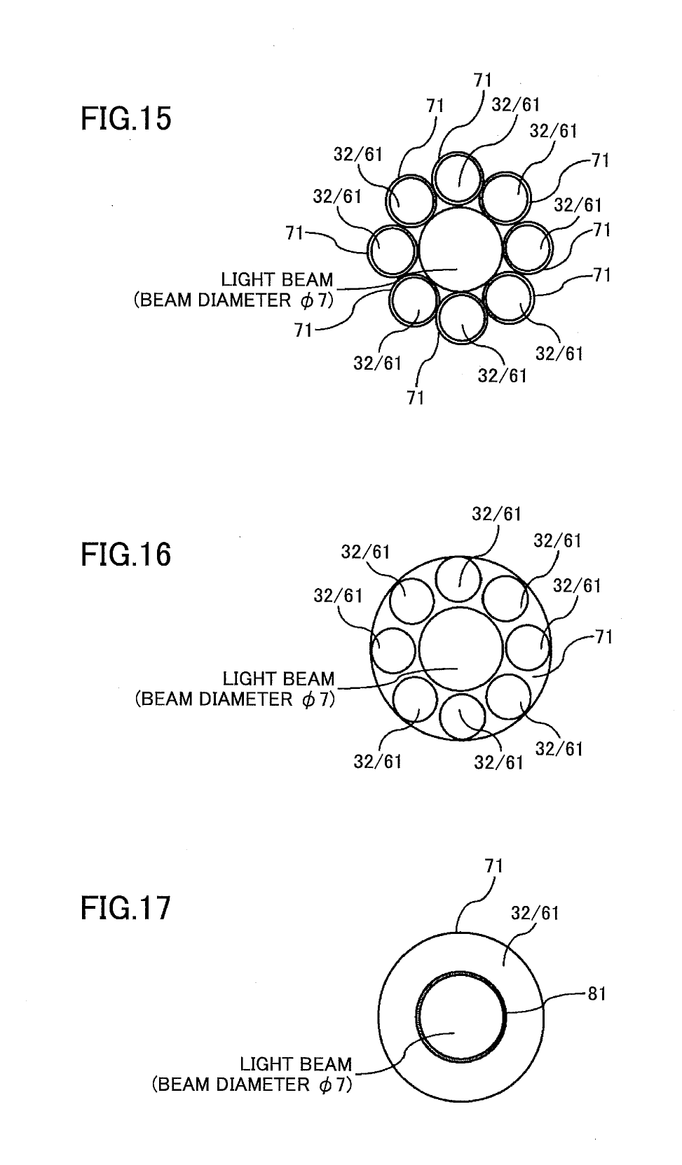

FIG. 15 is a diagram illustrating an example in such a manner that sets of a plurality of the wavelength filter 61 and the light-receiving element 32 arranged in the one light-blocking cylinder 71 are juxtaposed and arranged on a periphery of the light beam 23 with a beam diameter φ7. FIG. 16 is a diagram illustrating an example in such a manner that a plurality of sets of the wavelength filter 61 and the light-receiving element 32 are juxtaposed and arranged in the one light-blocking cylinder 71 larger than a beam diameter φ7 of the light beam 23. FIG. 17 is a diagram illustrating an example in such a manner that the wavelength filter 61 and the light-receiving element 32 are placed in the one light-blocking cylinder 71.

FIG. 15 to FIG. 17 illustrate diagrams illustrating configuration examples of a liquid drop ejection state detection device according to a seventh embodiment. A liquid drop ejection state detection device according to the present embodiment is such that a plurality of sets of the wavelength filter 61 and the light-receiving element 32 being arranged in the one light-blocking cylinder 71 are arranged in a periphery of the light beam 23 with a beam diameter φ7. Although a case of φ7=φ8 is illustrated, φ7≠8 may be provided.

FIG. 15 to FIG. 17, as one example, illustrate a condition that eight light-blocking cylinders 71 are arranged in a periphery of the light beam 23 with a beam diameter φ7, wherein shapes of the light-blocking cylinders 71 may be other shapes and the number thereof may also be arbitrary.

As a plurality of sets of the wavelength filter 61 and the light-receiving element 32 arranged in the one light-blocking cylinder 71 are juxtaposed and arranged on a periphery of the light beam 23 with a beam diameter φ7 in the liquid drop ejection state detection device according to the present embodiment, it is possible to provide total of amounts of light received by the respective light-receiving elements 32 and thereby increase an amount of received light due to scattered light S used for detection and measurement thereof, even when an amount of light of the light beam 23 emitted from the light-emitting element 28 is small.

Hence, as a plurality of the light-blocking cylinders 71 are juxtaposed and arranged on a periphery of the light beam 23 with a beam diameter φ7, it is possible to provide an amount of received light due to scattered light S as a total of amount of light received by the respective light-receiving elements 32 and detect an ejection state of the ink liquid drop 26, even when an amount of light of the light beam 23 emitted from the light-emitting element 28 is small.

Here, FIG. 15 is a case where a plurality of the light-blocking cylinders 71 are juxtaposed and arranged on a periphery of the light beam 23 with a beam diameter φ7. FIG. 16 is a case where a plurality of sets of the wavelength filter 61 and the light-receiving element 32 are juxtaposed and arranged in the one light-blocking cylinder 71 larger than a beam diameter φ7 of the light beam 23. Here, the wavelength filter 61 and the light-receiving element 32 as illustrated in FIG. 16 may have other shapes and the numbers thereof may also be arbitrary. Furthermore, a shape of the light-blocking cylinder 71 is also not limited to a circular one and may be another shape.

Furthermore, as illustrated in FIG. 15 described above, it is also possible to arrange the wavelength filter 61 and the light receiving element 32 that have diameters as illustrated in FIG. 17 and are placed in the one light-blocking cylinder 71, so as to satisfy an area for juxtaposing a plurality of the light blocking cylinders 71 on a periphery of the light beam 23 with a beam diameter φ7, and arrange a member 81 that does not transmit the light beam 23 to an area with the beam diameter φ7. Although FIG. 17 illustrates the wavelength filter 61, the light-receiving element 32, and the light-blocking cylinder 71 with a circular shape, as one example, other shapes may be provided.

Because the wavelength filter 61 and the light-receiving element 32 are thus placed on a periphery of the light beam 23 with a diameter φ7 in the liquid drop ejection state detection device according to the present embodiment, it is possible to increase an amount of received light that is received by the light-receiving element 32 even when an amount of light of the light beam 23 emitted from the light-emitting element 28 is small, and hence, it is possible to detect an ejection state of the ink liquid drop 26.

As described above, according to the present embodiment, a light-emitting element is moved by moving means in such a manner that a position with a high energy density of a light beam coincides with a center of an ink liquid drop and an amount of light emission of the light-emitting element is changed, so that an amount of light incident on an ink liquid drop ejected from each nozzle is set at a constant or arbitrary one and thereby it is possible for an amount of scattered light incident on a light-receiving element to be an optimum value, even when an inclination or a change in a nozzle interval of the light-emitting element is caused in a process for detecting an ejection state or when the position with a high energy density of a light beam is not present on a light axis thereof due to a characteristic of the light-emitting element, diffraction, or the like.

Furthermore, according to the present embodiment, it is possible to set an amount of light incident on an ink liquid drop ejected from each nozzle at a constant or arbitrary one by changing an amount of light emission of a light-emitting element and it is possible to eliminate means for adjusting an inclination angle with respect to a direction intersecting a light axis and a horizontal direction, so that it is possible to reduce a cost because means for adjusting an inclination angle with respect to a direction intersecting a light axis and a horizontal direction are not provided.

Furthermore, according to the present embodiment, it is possible to set an amount of light incident on an ink liquid drop ejected from each nozzle at a constant or arbitrary one by changing an amount of light emission of a light-emitting element, so that an amount of scattered light from an ink liquid drop is not reduced even when the number of nozzles are large or a nozzle interval is so large that a distance from a light-emitting element to a nozzle is large, and it is possible to detect a defect of ejection of an ink liquid drop accurately.

Furthermore, according to the present embodiment, a light-emitting element is moved by moving means in such a manner that a position with a high energy density of a light beam coincides with a center of an ink liquid drop and it is possible to provide an identical distance between horizontal positions of a nozzle sequence and a light-receiving element even when a position with a high energy density of a light beam is not present on a light axis thereof due to a characteristic of the light-emitting element, diffraction, or the like, so that an amount of scattered light incident on the light-receiving element is not reduced and hence, it is possible to detect a defect of ejection of an ink liquid drop accurately.

Moreover, according to the present embodiment, a light-emitting element is moved by moving means in such a manner that a position with a high energy density of a light beam coincides with a center of an ink liquid drop, so that it is possible to set an amount of light incident on an ink liquid drop ejected from each nozzle at a constant or arbitrary one even when an inclination of a light-emitting element or a change in a nozzle interval is caused.

Here, the embodiments described above are preferable embodiments of the present invention, wherein the scope of the present invention is not limited to only the embodiments described above and it is possible to implement modes with various modifications applied without departing from the essence of the present invention.

For example, it is also possible to execute a control operation for each part that composes the image formation apparatus or liquid drop ejection state detection device described above by using hardware, software, or a composite configuration thereof.

Furthermore, when a process is executed by using software, it is possible to be installed in a memory of a computer incorporated in dedicated hardware and execute a program that records a process sequence. Alternatively, it is possible to install and execute a program in a generalized computer capable of executing each kind of process.

For example, it is possible to record a program in a hard disk or a Read-Only Memory (ROM) as a recording medium preliminarily. Alternatively, it is possible to store (record) a program in a removable recording medium temporarily or permanently. It is possible to provide such a removable recording medium as package software.

Furthermore, for a removable recording medium, it is possible to provide a Floppy (registered trade mark) disc, a Compact Disc Read Only Memory (CD-ROM), a Magneto Optical (MO) disc, a Digital Versatile Disc (DVD), a magnetic disc, a semiconductor memory, or the like.

Furthermore, a program is installed from a removable recording medium as described above into a computer. Furthermore, wireless transfer from a download site to a computer is executed. Furthermore, a wire transfer through a network to a computer is executed.

Moreover, it is possible for the image formation apparatus or liquid drop ejection state detection device in the present embodiment to not only be executed in a time series in accordance with a processing operation described in the above-mentioned embodiment but also to be configured to execute devices for executing a process with a throughput in parallel or individually according to need.

### APPENDIX

<An Illustrative Embodiment(s) of a Liquid Drop Ejection State Detection Device and an Image Formation Apparatus>

At least one illustrative embodiment of the present invention may relate to at least one of a liquid drop ejection state detection device for detecting a defect of ejection of an ink liquid drop and an image formation apparatus.

An object of at least one illustrative embodiment of the present invention may be to provide a liquid drop ejection state detection device capable of detecting a defect of ejection of a liquid drop accurately, with no mechanical means for adjustment of a position or an inclination of a light axis and no necessity to increase light emission means in a case where a head sequence(s) is/are increased, without increasing an amount of light emission or an amount of offset light, by providing a mechanism capable of moving positions of light emission means and means for adjustment of amount of light emission of light emission means.

In order to attain such an object, at least one illustrative embodiment of the present invention may be a liquid drop ejection state detection device that has a light-emitting element for emitting a light beam, a light-receiving element arranged at a position displaced from a beam diameter of the light beam, and two or more head sequences that have a plurality of nozzles, wherein scattered light that is generated when the light beam impinges on a liquid drop from each nozzle of each head sequence is received by the light-receiving element and an ejection state of the liquid drop is detected based on an amount of received light that is the received scattered light, wherein the liquid drop ejection state detection device is characterized by having light emitting element movement means for moving the light emitting element in a direction intersecting with a light axis of the light beam and adjustment means for adjusting an amount of light emission of the light-emitting element.

Illustrative Embodiment (1) is a liquid drop ejection state detection device having a light-emitting element for emitting a light beam, a light-receiving element arranged at a position displaced from a beam diameter of the light beam, and two or more head sequences that have a plurality of nozzles, wherein scattered light that is generated when the light beam impinges on a liquid drop from each nozzle of each head sequence is received by the light-receiving element and an ejection state of the liquid drop is detected based on an amount of received light that is the received scattered light, wherein the liquid drop ejection state detection device is characterized by having light-emitting element movement means for moving the light-emitting element in a direction intersecting with a light axis of the light beam and adjustment means for adjusting an amount of light emission of the light-emitting element.

Illustrative Embodiment (2) is the liquid drop ejection state detection device as described in Illustrative Embodiment (1), characterized by a narrowing member for narrowing the light beam emitted from the light-emitting element.

Illustrative Embodiment (3) is the liquid drop ejection state detection device as described in Illustrative Embodiments (1) or (2), characterized in that the light beam is convergent light provided from collimated light.

Illustrative Embodiment (4) is the liquid drop ejection state detection device as described in any one of Illustrative Embodiments (1) to (3), characterized by having means for movement of the light-emitting element or a collimator lens in such a manner that the light beam is convergent light provided from collimated light.

Illustrative Embodiment (5) is the liquid drop ejection state detection device as described in any one of Illustrative Embodiments (1) to (4), characterized by having a wavelength filter that transmits only the scattered light with a wavelength identical to a wavelength of the light beam emitted from the light-emitting element, at a front side of the light-receiving element, wherein the light-receiving element receives the scattered light that has been transmitted through the wavelength filter.

Illustrative Embodiment (6) is the liquid drop ejection state detection device as described in Illustrative Embodiment (1) or (5), characterized in that the wavelength filter and the light-receiving element are provided in at least one light-blocking cylinder.

Illustrative Embodiment (7) is the liquid drop ejection state detection device as described in any one of Illustrative Embodiments (1) to (6), characterized in that the wavelength filter and the light-receiving element are placed on a periphery of a beam diameter of the light beam.

Illustrative Embodiment (8) is an image formation apparatus characterized by being provided with the liquid drop ejection state detection device as described in any one of Illustrative Embodiments (1) to (7).

According to at least one illustrative embodiment of the present invention, it may be possible to detect a defect of ejection of a liquid drop accurately, with no mechanical means for adjustment of a position or an inclination of a light axis and no necessity to increase light emission means in a case where a head sequence(s) is/are increased, without increasing an amount of light emission or an amount of offset light, by providing a mechanism capable of moving positions of light emission means and means for adjustment of an amount of light emission of light emission means.

Although the illustrative embodiment(s) and specific example(s) of the present invention have been described with reference to the accompanying drawing(s), the present invention is not limited to any of the illustrative embodiment(s) and specific example(s), and the illustrative embodiment(s) and specific example(s) may be altered, modified, or combined without departing from the scope of the present invention.

The present application is based on and claims the benefit of priority to Japanese Patent Application No. 2013-142557 filed on Jul. 8, 2013, the entire content(s) of which is/are herein incorporated by reference.

What is claimed is:

1. A liquid drop ejection state detection device, comprising:
a plurality of nozzle sequences configured to have a plurality of nozzles;
a light-emitting element configured to emit a light beam incident on a liquid drop from each nozzle of each nozzle sequence;
a light-receiving element provided at a position outside a beam diameter of the light beam and configured to receive scattered light from the liquid drop and detect an ejection state of the liquid drop based on an amount of the scattered light;
a light-emitting element movement part configured to move the light-emitting element in a direction intersecting with a light axis of the light beam; and
an adjustment part configured to adjust an amount of light of the light beam emitted from the light-emitting element.

2. The liquid drop ejection state detection device as claimed in claim 1, further comprising:
a narrowing member configured to narrow the light beam emitted from the light-emitting element.

3. The liquid drop ejection state detection device as claimed in claim 1, wherein the light beam is a convergent light beam.

4. The liquid drop ejection state detection device as claimed in claim 3, further comprising:
a lens configured to transmit the light beam emitted from the light-emitting element; and
a movement part configured to move at least one of the light-emitting element and the lens to provide the convergent light beam.

5. The liquid drop ejection state detection device as claimed in claim 1, further comprising:
a wavelength filter configured to transmit the scattered light with a wavelength identical to a wavelength of the light beam emitted from the light-emitting element,
wherein the light-receiving element receives the scattered light transmitted through the wavelength filter.

6. The liquid drop ejection state detection device as claimed in claim 5, further comprising:
a light-blocking cylinder configured to contain the wavelength filter and the light-receiving element therein.

7. The liquid drop ejection state detection device as claimed in claim 5, wherein the wavelength filter and the light-receiving element are provided on a periphery of the light beam.

8. An image formation apparatus, comprising:
a recording medium conveyance part configured to convey a recording medium; and
the liquid drop ejection state detection device as claimed in claim 1,
wherein the liquid drop ejection state detection device detects an ejection state of the liquid drop onto the recording medium.
